(19) United States
(12) Patent Application Publication
(10) Pub. No.: US 2014/0023923 A1
(43) Pub. Date: Jan. 23, 2014

(54) STRUCTURED ARRESTER FOR BATTERY CELLS

(71) Applicant: Richard Aumayer, Diekholzen (DE)

(72) Inventor: Richard Aumayer, Diekholzen (DE)

(73) Assignee: Robert Bosch GMBH, Stuttgart (DE)

(21) Appl. No.: 13/984,242

(22) PCT Filed: Dec. 8, 2011
(86) PCT No.: PCT/EP11/72150

§ 371 Date: Oct. 10, 2013

(30) Foreign Application Priority Data
Feb. 7, 2011 (DE) 10 2011 003 722.5

(51) Int. Cl. H01M 4/70; H01M 4/04

(52) U.S. Cl. CPC H01M 4/70; H01M 4/0402
USPC 429/211; 29/623.5

(57) ABSTRACT

An arrester for a battery cell is described, the arrester essentially being formed from a conductive foil, wherein the conductive foil has structural components which enlarge the effective contact area between the foil and an active mass covering the foil when compared with the basic area of the foil. In addition, a method is described for producing a corresponding arrester and a battery cell having such an arrester.

### FIELD OF THE INVENTION

The present invention relates to an arrester for a battery cell, the arrester essentially being formed by a conductive foil, wherein the conductive foil has structured elements which enlarge the effective contact area between the foil and an active mass covering the foil, in comparison with the basic area of the foil. In addition, the present invention relates to a method for producing a corresponding arrester and a battery cell having such an arrester.

### BACKGROUND INFORMATION

Battery cells have been used as energy stores for electrical energy for a long time in the related art. Battery cells within the meaning of the present invention are both batteries and accumulators. Battery cells for storing electrical energy which are made up of one or more storage cells are known, in which in response to the application of a charge current, electrical energy is converted into chemical energy and thus stored in an electrochemical charge reaction between a cathode and an anode in or between an electrolyte, and in which chemical energy is converted into electrical energy in an electrochemical discharge reaction when an electrical consumer is connected. Accumulators allow multiple charge and discharge cycles, whereas battery usually can be charged only once and must be recycled after discharge. Batteries on the basis of lithium compounds have gained in importance over the past few years. Such lithium-based cells have high energy density and thermal stability, supply a constant voltage at low spontaneous discharges, and are free of the so-called memory effect. It is known to produce battery cells and, in particular, lithium battery cells in the form of thin plates. In such cells the cathode and anode material, accumulators (hereinafter called arresters) and separators in the form of thin foils are placed on top of one another (stacked) in suitable manner and packaged in a cover foil. The cathodes and anodes are formed by arresters and an active mass deposited thereon on one or both side(s). The arresters of the cathode and anode laterally project at an edge of the cell and thereby are able to be contacted in current-carrying manner. Such lithium-ion batteries or accumulators are currently used as energy stores in a multitude of products. For example, the use of such energy stores is known from the field of portable computer systems or telecommunication. Intensive discussions are currently taking place about their use in the automotive sector as well, as drive battery in motor vehicles. Excellent contact between the active masses and the electrodes across a multitude of charge cycles is required in this context, especially in order to achieve long durability of the battery cells.

German Published Patent Appln. No. 69429153 T2 describes a porous metal sheet provided with a circuit track, and it describes a method for producing it, as well as a porous metal sheet provided with a circuit track, in particular, which preferably is used as spiral-shaped electrode plate of a battery. In order to make it possible to use a porous metal sheet as spiral-shaped electrode plate, which sheet is formed using a combination of porous mats such as a foam mat, a piece of non-woven part material and a mesh mat, or only one of these three types of mats, an active substance is filled into pores of the porous metal sheet. In this way circuit tracks consisting of continuous solid metal and acting as accumulator elements for accumulating electrical current are formed along the peripheral edge of the spiral-shaped electrode.

### SUMMARY

The present invention provides an arrester for a battery cell; in principle, the arrester is formed by a conductive foil, the arrester being characterized by structured elements provided on the conductive foil which enlarge the effective contact area between the foil and an active mass covering the foil in comparison with the basic area of the foil. The electrically conductive foil preferably is a metal foil.

Because of the larger effective contact surface between the foil and the active mass created by the structured elements provided according to the present invention, the adhesion between arrester and active mass is improved. In addition, the contact resistance between arrester and active mass is reduced. This and the improved adhesion contribute to greater durability and a longer service life of the cell.

In one refinement of the present invention, the structured elements are developed as protrusions which are essentially distributed uniformly across the basic area of the foil. This further improves the adhesion between the active masses and the arrester.

In one further development of the present invention, the structured elements have a maximum projection from the plane of the basic area of the foil that is less than the sum of the thickness of the foil and the thickness of the active mass deposited thereon. In one preferred development, the structured elements are developed on both sides of the foil. In furthermore preferred manner, the number of structured elements per area decreases in the region of the arrester vane, so that the higher current density that occurs at this location when the cell is charged and/or discharged is able to be absorbed. The ratio of basic area to height of the structured elements preferably is such that the foil material of the arrester is only stretched but does not tear, so that holes are avoided.

According to the present invention, the structured elements are able to be introduced into the foil using a roller and/or a stamp. The protrusions of the roller and/or the stamp for forming the structured elements preferably are rounded at their tip in order to avoid the creation of holes in the foil in the region of these structured elements.

The surface of the arrester enlarged by these structured elements leads to improved adhesion between arrester and active material, which reduces the contact resistance between arrester and active mass. This improves the durability and service life of the battery cell.

In one further development of the present invention, the structured elements have a maximum projection from the plane of the basic areas of the foil that is greater than, or equal to, the sum of the thickness of the foil and the thickness of the active mass deposited thereon. It is especially preferred in this context if the foil has perforations in the region of these structured elements. This type of structured elements to be provided according to the present invention is able to be introduced into the foil material of the arrester with the aid of a roller, a stamp or a die, for example, the projections of these tools being developed as pegs that are pushed into the foil material. These pegs are preferably provided with cutters at their tips in order to make it easier to penetrate the foil material. It is furthermore preferred if the number of cutters per peg is ≧3.

According to the present invention, it may be the case that the pegs bend the foil material open with the aid of the cutter, so that the height of the bent open sections lies above the thickness of the completely calendered electrode such that it equals the compression of the active material in the calendering step, e.g., 0.1 to 0.2 mm. In the calendering step, these bent-open sections are then at least partially bent in the direction of the active mass, which leads to mechanical bracing of the active mass on the arrester. This bracing also results in improved adhesion between arrester and active material, which reduces the contact resistance between arrester and active mass.

In one further development of the present invention, the arrester has both structured elements which have a maximum projection from the plane of the basic areas of the foil that is less than the sum of the thickness of the foil and the thickness of the active mass applied thereon, and structured elements of the type that have a maximum projection from the plane of the basic areas of the foil that is greater than, or equal to, the sum of the thickness of the foil and the thickness of the active mass applied thereon, these elements causing a perforation of the foil material in this region or to the foil material being bent open. Because of this combination, a larger adhesion surface between arrester and active mass is achieved, as well as mechanical bracing of the active mass on the arrester.

Moreover, the present invention provides a method for producing an electrode for a battery cell, which method includes the following method steps:
providing a conductive foil;
introducing structured elements into the foil, the structured elements having a maximum projection from the plane of the basic areas of the foil that is smaller than the sum of the thickness of the foil and the thickness of the active mass deposited thereon, and the foil is free of perforations in the region of the structured elements, and/or the structured elements have a maximum projection from the plane of the basic areas of the foil that is greater than, or equal to, the sum of the thickness of the foil and the thickness of the active mass applied thereon, and the foil has perforations in the region of the structured elements and the structured elements are evenly distributed across the basic area of the foil;
applying an active mass on the structured foil; and
pressing the active mass onto the structured foil.

In one development of the method according to the present invention, the structured elements are introduced into the foil using a roller, a stamp and/or a die.

In one further development of the method, the active mass is pressed onto the structured foil such that sections of the structured elements projecting from the applied active mass are bent in the direction of the active mass.

Ultimately, the object of the present invention is also achieved by a battery cell which includes at least one arrester of the type described earlier and which preferably was produced by a method as described previously already.

### BRIEF DESCRIPTION OF THE DRAWINGS

FIG. 1 shows a schematic view of an arrester according to the present invention.

FIG. 2 shows an electrode formed by an arrester according to the present invention and an active mass.

FIG. 3 shows a detail view of a structured element to be provided according to the present invention.

FIG. 4 shows a detail view of another structured element to be provided according to the present invention.

FIG. 5 shows an electrode formed by an arrester according to the present invention and an active mass, prior to and following a calendering step.

### DETAILED DESCRIPTION

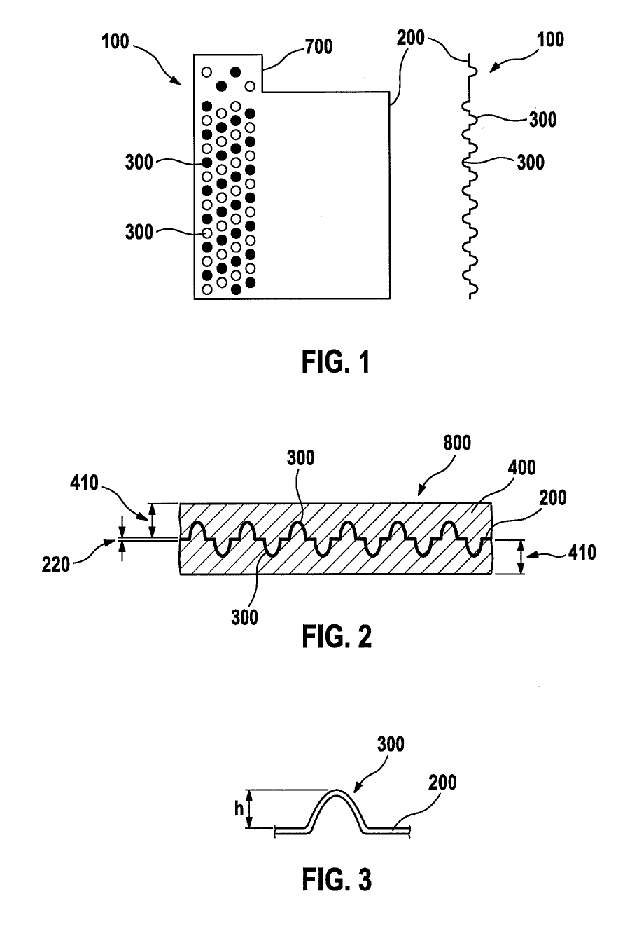

FIG. 1 shows a schematic view of an arrester 100 according to the present invention. The arrester is made of a conductive metal foil 200, on which structured elements 300 are situated at regular intervals. Structured elements 300 have a maximum projection from the plane of the basic areas of foil 200 that is less than the sum of thickness 220 of foil 200 shown in FIG. 2, and thickness 410 of active mass 400 applied thereon. Arrester 100 has an arrester vane 700 in the upper region, via which the arrester is electrically contactable. In the arrester region, the number of structured elements 300 per area is lower than in the remaining region of arrester 100 in order to be able to absorb the higher current density that occurs in that location during the charging and/or discharging of the battery cell in which arrester 100 is provided. The ratio of basic area to the height of structured elements 300 preferably is such that the material of which foil 200 is made is only stretched but does not tear, so that holes are avoided. Structured elements 300 project from both sides of foil 200, so that a larger adhesive surface is available to the active material applied on both sides. The introduction of structured elements 300 into foil 200 is able to be implemented by a roller and/or a stamp. The protrusions of the roller and/or the stamp for forming structured elements 300 preferably are rounded at their tip in order to avoid the creation of holes in the foil in the region of these structured elements.

FIG. 2 shows an electrode 800 formed by an arrester according to the present invention and an active mass 400. An active mass 400 having a mass 410 is applied on an arrester 100 having a thickness 210, which is patterned with structured elements according to the present invention on both sides. Structured elements 300 in conductive foil 200 are developed in such a way that their height is less than height 410 of applied mass 400, i.e., following a calendering step in which active material 400 is press-fitted with arrester 100. In the present invention, it may be provided that different masses are applied on the two sides of the arrester, at least partially.

FIG. 3 shows a detail view of a structured element 300 to be provided according to the present invention. To introduce structured elements 300 into the foil material, foil 200 may be guided across a roller and/or a stamp, which have/has the form of the positive impression of the desired form of structured element 300 and are/is provided with rounded tips. The ratio of basic area to height h of the structured elements preferably is such that the foil material of the arrester is only stretched but does not tear, so that holes are avoided.

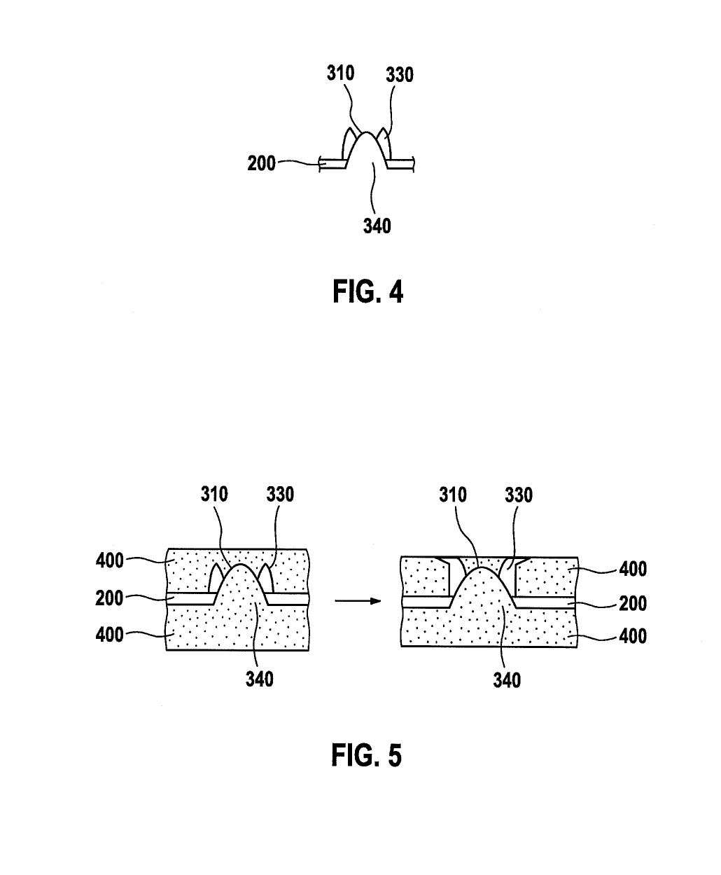

FIG. 4 shows a detail view of another structured element 310 to be provided according to the present invention. In this structured element 310, the maximum projection from the plane of the basic area of foil 200 is greater than, or equal to, the sum of thickness 220 of foil 200, and thickness 410 of active mass 400 applied thereon. Foil 200 is perforated in the region of structured elements 310, so that wings 330 of structured element 310 reach into or even beyond active mass 400 to be applied, as shown in FIG. 5. The structured elements preferably are introducible into foil 200 by a stamp or a roller. Following and/or during the calendering of the electrode formed by arrester 100 and the active mass applied thereon, wings 330, which reach into active mass 400, are bent in the direction of active mass 400, so that the active mass is able to be retained in the way of a clamp with the aid of bent wings 330. This improves the mechanical adhesion between arrester 100 and active mass 400 applied thereon.

1.-10. (canceled)

11. An arrester for a battery cell, comprising:
a conductive foil; and
an active mass covering the foil, wherein the foil includes structured elements that enlarge an effective contact surface between the foil and the active mass covering the foil, in comparison with a basic area of the foil.

12. The arrester as recited in claim 11, wherein the structured elements are developed as projections which are distributed essentially uniformly across the basic area of the foil.

13. The arrester as recited in claim 11, wherein the structured elements have a maximum projection from a plane of the basic area of the foil that is smaller than a sum of a thickness of the foil and a thickness of the active mass applied thereon.

14. The arrester as recited in claim 11, further comprising:
an arrester vane, wherein the foil has a lower number of structured elements per area in a region of the arrester vane, than in a remaining area of the arrester.

15. The arrester as recited in claim 11, wherein the structured elements have a maximum projection from a plane of the basic area of the foil that is one of greater than and equal to a sum of a thickness of the foil and a thickness of the active mass applied thereon.

16. The arrester as recited in claim 11, wherein the foil includes perforations in a region of the structured elements.

17. A battery cell, comprising:
at least one arrester that includes:
a conductive foil; and
an active mass covering the foil, wherein the foil includes structured elements that enlarge an effective contact surface between the foil and the active mass covering the foil, in comparison with a basic area of the foil.

18. A method for producing an electrode for a battery cell, comprising:
providing a conductive foil;
introducing structured elements into the foil, wherein:
the structured elements have a maximum projection from a plane of a basic area of the foil that is smaller than a sum of a thickness of the foil and a thickness of an active mass deposited thereon,
at least one of:
the foil is free of perforations in a region of the structured elements, and
the structured elements have a maximum projection from the plane of the basic area of the foil that is one of greater than and equal to a sum of the thickness of the foil and a thickness of the active mass applied thereon, the foil has perforations in the region of the structured elements, and the structured elements are evenly distributed across the basic area of the foil;
applying the active mass on the structured foil; and
pressing the active mass onto the structured foil.

19. The method as recited in claim 18, wherein the structured elements are introduced into the foil with the aid of at least one of a roller, a stamp, and a die.

20. The method as recited in claim 19, wherein the pressing of the active mass onto the structured foil is implemented in such a way that sections of the structured elements projecting from the applied active mass are bent in a direction of the active mass.
